(19) United States
(12) Patent Application Publication
(10) Pub. No.: US 2020/0035030 A1
(43) Pub. Date: Jan. 30, 2020

(54) AUGMENTED/VIRTUAL MAPPING SYSTEM

(71) Applicants: Aaron Schradin, West Olive, MI (US); Joshua LaRue, Austin, TX (US); Christopher A. Eusebi, Bloomfield Township, MI (US)

(72) Inventors: Aaron Schradin, West Olive, MI (US); Joshua LaRue, Austin, TX (US); Christopher A. Eusebi, Bloomfield Township, MI (US)

(21) Appl. No.: 16/478,778

(22) PCT Filed: Jan. 17, 2018
(86) PCT No.: PCT/US18/14056

§ 371 Date: Jul. 17, 2019

Related U.S. Application Data
(60) Provisional application No. 62/447,329, filed on Jan. 17, 2017.
(60) Provisional application No. 62/524,317, filed on Jun. 23, 2017.

(51) Int. Cl. G06T 19/00; G06T 17/05; G06T 17/30

(52) U.S. Cl. CPC G06T 19/006; G06T 2219/024; G06T 17/30; G06T 17/05

(57) ABSTRACT

According to the present teachings a system is provided having a landscape engine configured to take digital input and convert it into three dimensional at virtual reality dataset. The landscape engine is functionally coupled to a physics engine configured to physical rules to objects within the virtual reality dataset. A display engine is coupled to the physics engine to convert the dataset into first and second content streams.

### CROSS-REFERENCE TO RELATED APPLICATIONS

This application claims the benefit of PCT/US18/14056, filed on Jan. 17, 2018, U.S. Provisional Application No. 62/447,329, filed on Jan. 17, 2017 and U.S. Provisional Application No. 62/524,317, filed on Jun. 23, 2017. The entire disclosure of the above applications are incorporated herein by reference.

### FIELD

The present disclosure relates to an augmented reality system to be used in a supervised operation.

### SUMMARY

According to the present teachings, the AR/VR training and mapping system allows users or soldiers to gain situational comfort for by training in a virtual training environment, and optionally followed by an augmented training environment. This increases the speed at which the users absorb memories about a terrain. Information from the VR and AR environments can be used in a mixed reality (MR) situation or real mission the information provides a more memorable experience for retention of the knowledge of the terrain.

According to the present teachings a system is provided having a landscape engine configured to take digital input and convert it into three dimensional at virtual reality dataset. The landscape engine is functionally coupled to a physics engine (such as by way of non-limiting example the unreal engine) configured to physical rules to objects within the virtual reality dataset. A display engine is coupled to the physics engine to convert the dataset into first and second content streams.

According to the present teachings the system includes a first VR headset configured to receive the first content and a first AR headset configured to present a second dataset onto an AR display.

According to the present teachings the system includes training scenarios wherein the first dataset comprises a rendered topographic landscape.

According to the present teachings the system includes a second dataset having an augmented reality content that is less than the content of the first dataset.

According to another teaching, a method for training a solder is presented. The method includes capturing a series of images for a terrain using a drone. The image data series of the terrain is converted into a captured set of images and into a wire frame of the topographic landscape. The system syncs the wire frame of the topographic landscape to a real world located using a fixed coordinate system such as gps. The system then optionally provides a set of polygons over the wire frame to form a virtual reality image dataset.

The system applies a physics engine to object within the VR image dataset. The VR data set is coupled to a display engine which provides a first VR image dataset stream to a VR display. The display engine also provides a second AR image dataset less than the first VR image dataset which is streamed to an AR display. The training system according to the aforementioned system where the first VR image dataset includes a selecting engageable virtual sandbox which gives an overhead view of the entire topography, and in VR data space topography.

The training system according to the aforementioned system wherein the second AR image dataset is polygons for texture and content selectively disposed onto a real world optically viewable surface through an AR display and fourth set of data which overlays a wire frame image over real word surfacing in an augmented reality goggles.

According to a new teaching, the landscape engine can selectively accept data from GIS, 3-D heat map data from an FLIR image, data from a Lidar imaging system, and combinations thereof and augment portions of the VR landscape by applying layers of the new information.

According to a new teaching, the aforementioned system can include a dataset having image data for items such as a vehicles, or red team personnel that are placeable by the first person onto the sandbox, these items also being simultaneously positioned within the VR space, where they are affected by rules defined by the physics engine.

The system according to the aforementioned systems further having a difference engine which compares a first image with a second image. The difference engine highlighting changes between the first and second images within at least one of the sand box, VR and MR datasets.

According to another teaching, the difference engine calculates changes in elevation of ground of greater than 5 mm, placement of vehicles, changes in thermal energy emitted from a portion of the image.

According to another teaching, a physics engine can selectively apply vary light conditions to the display data.

According to another teaching, the physics engine can selectively apply varying weather conditions to the display data.

According to another teaching, the aforementioned systems can further include a distance calculator which can calculate distance between two locations in one of the virtual dataset and the AR world.

According to another teaching, the system can further include an injury probability system which calculates a probably of injury for a given path in VR, AR, MR space and highlights least probability of injury paths in VR, AR, MR space and changes the probabilities based on changes in the VR, AR, MR space model.

According to another teaching, the aforementioned systems can utilize intelligent CNC cutter-path mathematics to define the path of a data collection drone to most efficiently calculate needed information for a variety of layers in a variety of spectrum. This will allow, the maintenance a constant data buffering rates to minimize data feed rate losses and to maximize program processing speed.

“Smart imaging” is a feature that aims to produce an intelligent, optimized drone path. Its functionality can include options for examining data between Z layers—including data feed connections, slope control flight, and geometry identification. To achieve near net shape when imaging, it is important for the control software to understand what changes in surface topology occur between the layers of down-steps. Knowledge of terrain remaining algorithms must look ahead to determine where extra closer imaging-steps are necessary. Smart imaging is how a flight control system images this “between layers” material. By rough imaging in this manner, often the semi-finish pass may be eliminated, saving on drone flight time and computation resources. Smart imaging may also include helical ramping functionality. This is used for pocket imagine. The helical ramping function determines helical movement based on entry angle and geometry. This function is most important when the imager reaches an obscured area of terrain. It can make the drone path shorter and safer by eliminating unneeded duplication, as a result of tailoring the tool path to the geometry of the obscured features.

According to the present teachings, the system can map available electromagnetic spectrum including EM radio signal dead zones and the location of transmitters within the VR, AR, MR dataset.

According to the present teachings, a method and system for sharing a three-dimensional virtual reality space among a plurality of users is provided. The method includes the step of, acquiring three-dimensional graphics data associated with a geographic region to be used by the plurality of users in a shared manner using a mobile platform such as an autonomous vehicle first and second times. Noting when objects or surfaces within the geographic region whose state is changed between the first and second time is changed during a predetermined time period. The method includes the step of functionally coupling the three-dimensional graphics data to a physics engine configured to physical rules to objects within the virtual reality dataset. Additionally, the method includes functionally coupling a display engine coupled to the physics engine to convert the dataset into first and second content streams. The method includes streaming a first content set from the three-dimensional graphics data to a VR headset and a second content set three-dimensional graphics data to an AR headset.

The method and system according to a previous or following paragraphs wherein streaming a first content set includes streaming training scenarios and wherein the first dataset comprises a rendered topographic landscape.

The method or system according to a previous or following paragraphs wherein the second dataset has an augmented reality content that is less than the content of the first dataset.

The method or system according to a previous or following paragraphs including capturing a series of images for a terrain using a drone and converting into a captured set of images and into a wire frame of the topographic landscape.

The method or system according to a previous or following paragraphs including the topographic landscape to a real world located using a fixed coordinate system.

The method or system according to a previous or following paragraphs including providing a set of polygons over the wire frame to form a virtual reality image dataset.

The method or system according to a previous or following paragraphs including providing a second AR image dataset having less content than the first VR image dataset which is streamed to an AR display.

The method or system according to a previous or following paragraphs wherein providing a first VR image dataset includes a selecting engageable virtual sandbox which gives an overhead view of the entire topography, and in VR data space topography.

According to another embodiment, a method or system for training a soldier is provided. The method or system includes the steps of capturing a series of images for a terrain using a drone or flying mobile platform. The method or system includes the steps of converting the image data series of the terrain into a captured set of images and into a wire frame of the topographic landscape. The method or system includes syncing the wire frame of the topographic landscape to a real world located using a fixed coordinate system. The method or system includes applying a physics engine to object within the VR image dataset. The method or system includes streaming a first image dataset stream to a VR display, and a second AR image dataset less than the first VR image dataset which is streamed to an AR display.

The method or system according to a previous or following paragraphs includes sharing a three-dimensional virtual reality space among a plurality of users. The method or system can include acquiring a plurality of images of a geographic region using a mobile platform.

The method according to one or more of the previous or following paragraphs includes using photogrammetry to create a first set of three-dimensional graphics data associated with a geographic region to be used by the plurality of users in a shared manner. The three-dimensional graphics data is functionally coupled to a physics engine configured to physical rules to objects within the virtual reality dataset. A display engine is coupled to the physics engine to convert the dataset into first and second content streams. One of the first content streams and second content streams from the three-dimensional graphics data is selectively streaming either to a VR headset.

The method or system according to one or more of the previous or following paragraphs wherein streaming a first content stream includes streaming the first dataset which comprises a rendered topographic landscape.

The method or system according to one or more of the previous or following paragraphs wherein streaming a second content stream includes streaming the second dataset has an augmented reality content that is less than the content of the first dataset.

The method or system according to one or more of the previous or following paragraphs includes capturing a series of images for a terrain using a drone and converting into a captured set of images and into a wire frame of the topographic landscape.

The method or system according to one or more of the previous or following paragraphs includes syncing the topographic landscape to a real world located using a fixed coordinate system.

The method or system according to one or more of the previous or following paragraphs includes providing a set of polygons over the wire frame to form a virtual reality image dataset. The method or system according to one or more of the previous or following paragraphs includes providing a second AR image dataset having less content than the first VR image dataset which is streamed to an AR display.

The method or system according to one or more of the previous or following paragraphs wherein providing a first VR image dataset includes a selecting engageable virtual sandbox which gives an overhead view of the entire topography, and in VR data space topography.

According to a further teaching, a method for training a soldier is disclosed. The method includes the steps of capturing a series of images for a terrain using a drone. The method includes converting the image data series of the terrain into a captured set of images and into a wire frame of the topographic landscape. The method includes syncing the wire frame of the topographic landscape to a real world located using a fixed coordinate system, and applying a physics engine to object within the VR image dataset. The method or system includes further streaming a first image dataset stream to a VR display; and streaming a second image dataset to the VR display.

### DRAWINGS

The drawings described herein are for illustrative purposes only of selected embodiments and not all possible implementations, and are not intended to limit the scope of the present disclosure.

FIG. 1 is a system schematic according to the present teachings;

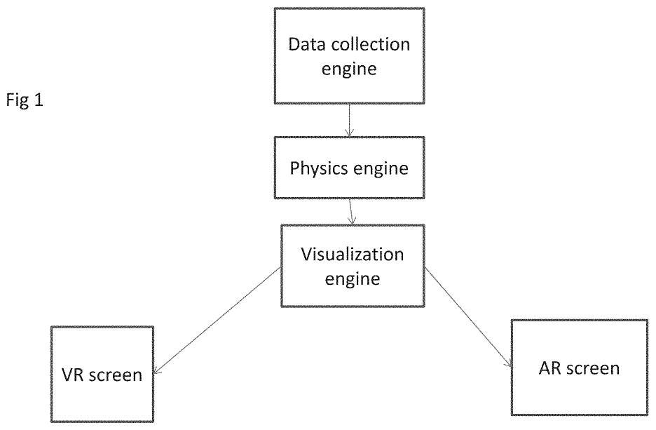

FIG. 2 is a first image of the VR system showing a virtual sandbox;

FIG. 3 is a second image within the VR system showing a staging area;

FIG. 4 is a third image within the VR system showing a distance calculation area;

FIG. 5 is an image of the sand table showing calculated high risk path; and

FIG. 6 represents a training timeline;

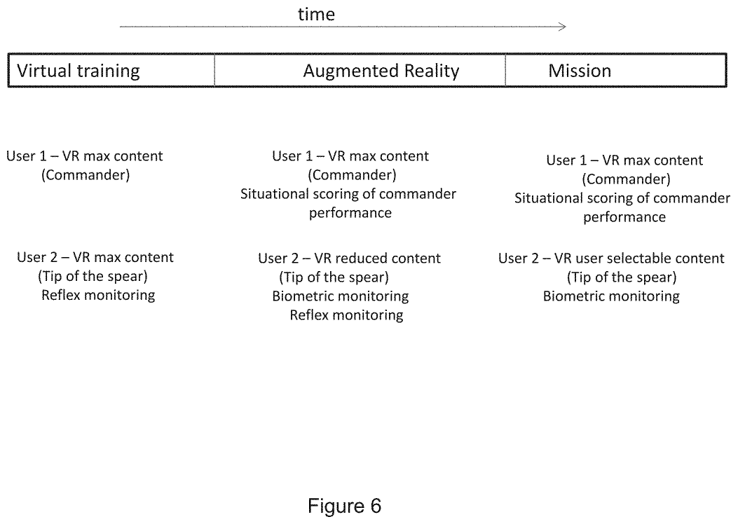

FIG. 7 represents a representative database according to the teachings of the present inventions;

FIG. 8 represents the system used to manage images and videos from the mobile platform; and

FIG. 9 represents a system for optimizing a flight path for a camera supporting mobile platform.

Corresponding reference numerals indicate corresponding parts throughout the several views of the drawings.

### DETAILED DESCRIPTION

Example embodiments will now be described more fully with reference to the accompanying drawings.

A system and associate set of methods for training personnel or solder is presented. The system generally uses an autonomous vehicle, e.g. a drone that captures a series of images for a terrain. The image data series of the terrain is converted into a captured set of images and into a wire frame of the topographic landscape. The system syncs the wire frame of the topographic landscape to a real world located using a fixed coordinate system such as gps. The system then optionally provides a set of polygons over the wire frame to form a virtual reality image dataset.

The system applies a physics engine to object within the VR image dataset. The VR data set is coupled to a display engine which provides a first VR image dataset stream to a VR display. The display engine also provides a second AR image dataset less than the first VR image dataset which is streamed to an AR display. The training system according to the aforementioned system where the first VR image dataset includes a selecting engageable virtual sandbox which gives an overhead view of the entire topography, and in VR data space topography.

The second AR image dataset is polygons for texture and content selectively disposed onto a real world optically viewable surface through an AR display and fourth set of data which overlays a wire frame image over real word surfacing in an augmented reality goggles.

For data input data can come from image or sensor data from man based sensors, machine based sensors, Man/Machine. The System can optimize the path of the drone utilizing intelligent CNC cutter-path mathematics to define the path of a data collection drone to most efficiently calculate needed information for a variety of layers in a variety of spectrum. This will allow, the maintenance a constant data buffering rates to minimize data feed rate losses and to maximize program processing speed.

The flight path for the drone can be set based upon the area being photographed. In this regard, when there are large differences between the heights of buildings, a spiral flight path is often best. Additionally, using image object differentiation and shadow lengths. The flight path can be prioritized to take more images or images with a greater image angle where there are features such as roads between buildings and or buildings with large differences in height.

A “Smart Imaging” control for the drone aims to produce an intelligent, optimized drone path. Its functionality can include options for examining data between Z layers—including data feed connections, slope control flight, and geometry identification. To achieve near net shape when imaging, it is important for the control software to understand what changes in surface topology occur between the layers of down-steps. Knowledge of terrain remaining algorithms must look ahead to determine where extra closer imaging-steps are necessary. Smart imaging is how a flight control system images this “between layers” material. By rough imaging in this manner, often the semi-finish pass may be eliminated, saving on drone flight time and computation resources. Smart imaging may also include helical ramping functionality. This is used for pocket imagine.

The helical ramping function determines helical movement based on entry angle and geometry. This function is most important when the imager reaches an obscured area of terrain. It can make the drone path shorter and safer by eliminating unneeded duplication, as a result of tailoring the tool path to the geometry of the obscured features.

The sensors can calculate color, distance, heat emission, reflectivity, emissivity, and density. The data can be collected from Air, Land, Sea, and Space (satellite) machines —manned or unmanned. Data layers are mathematically processed into proper formats for system integration for user integration. Layers are created to allow users to observe the machine data in the proper spectrum to allow for enhanced decision-making and proper intuition prompts. Points are tessellated and properly approximated to create a mapping system that represents the area of activity.

Optionally when an earth based frame of reference is not known, for instance within a building. Simultaneous localization and mapping (SLAM) techniques can be used to create VR datasets for unknown areas in cave/mine/indoor rescue scenarios.

With respect to the electromagnetic atmosphere, the VR and MR system can be used to display and show a scan cellular flow of cell phones for enhanced civil planning to track how many cars go which way, as well as the location of various towers. Additionally, Oil—Ground Scans provide locations of minerals/oil geo-referenced in the ground to augmented reality. Drilling for water reference local aquifer map while drilling for water wearing AR goggles you can see how close your pipe is in relation to aquifer.

Software and swarm Identifies differences in 3D landscape reality to provide prompts on areas of further inspection. An imagining engine or processor contains the ability to combine SLAM with Photogrammetry and older 3d models. In this regard, once a sparse mesh is calculated in photogrammetry, a determination is made if enough tie points are available. If there not enough tie points available, the system can send out a second drone to take more images.

When there is incomplete or old data in high priority areas, the System AI can display prioritized drone flight patterns to focus surveillance detection on differences based on outputs for a difference engine or algorithm. Optionally, heightened scrutiny will be available for 3D landscape and indicators differences and anomalies human activity.

The head of an actor or drones can include a sensor package, either virtual or real which provides the system physics engine which indicates where hits are made with weapons calculate probability of lethality and offer indication as to keep shooting or not. Facial and or voice recognition indicates whether bad actor is HVT or pawn. Optionally the intuition prompts shows target-to-target head or leg.

Recordings of the movement inside the VR or AR simulator can be monitored by instructors or our public version can be checked for high value targets OTMs. This allows a team to can go back in time and revisit old missions and replay scenarios from raw data gathered before the creation of the model.

The physics engine initiates and references area of activity. The area of activity is presented in several scales. Of which is miniature for an overview/observance and another is full scale for full immersion. The physics engine allows the first user or System AI to have the ability to properly set time, sun/star position and weather effects.

Recordings of users inside the VR simulator can be monitored by instructors or our public version can be checked for HVT OTMs. This allows a team to can go back in time and revisit old missions and replay scenarios from raw data gathered before the creation of a VR sand table.

Geo-referenced 3D data for ballistic calculations of probabilities of mortal impact both good and bad side. Percentages of hitting and not being hit shown in Augmented Reality to provide confidence on the battlefield.

Live wind and altitude and angle of shot calculations done in augmented reality. For added Confidence for shooters, the location of indicia for wind speed —flags that can be identified and highlighted in VR, MR, and AR. This allows collectively get better wind data at multiple points in a valley using drones to drift them in the wind. Better-fit ballistic calculations can be suggested to a user using intuition prompts.

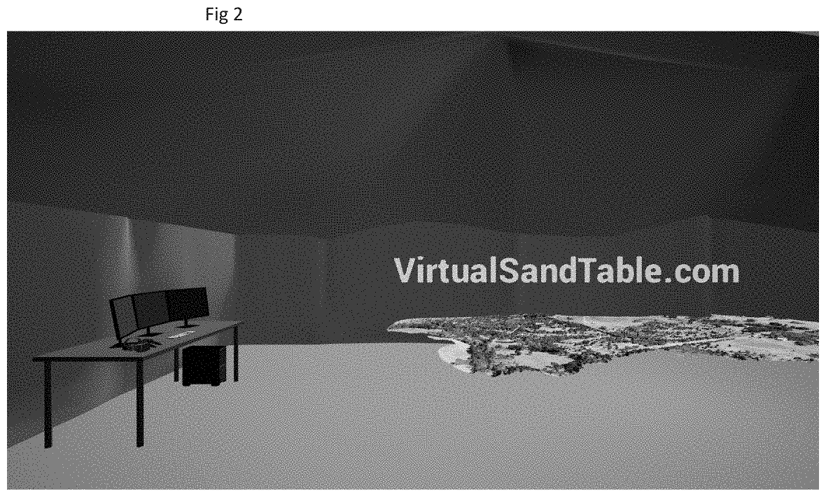

The display engine will track all users for easy teleportation within the VR space. As shown in FIG. 2, the sandbox view represents a Minimap that shows user positions and includes a RangeFinder—Point to Point, User—Identification, a Compass that can be sky compass in VR and AR situations. The first person or commander can walk around the sandbox in the virtual space. The system contains a database of weather options that will affect for example travel speed, visibility. The system can include a back move button —teleport back to previous location.

Drawing within the system can be done with decals. Each time a raytrace hits a mesh it adds a decal to its surface. Performance can be reduced quickly so optionally, limited the amount of decals that can be drawn but more will need to be done here. Ideally the system uses a raytrace to static mesh and gather the UV coordinate of the hit and then add pixels to a “paint” texture at those coordinates. This will mean the only decrease in system speed and refresh rate is the texture memory and a single draw call instead of potentially thousands of draw calls per decal. Multiple users are displayed onto the sandbox view of the VR and in the VR space. To better simulate real world environments, when moving through the VR space, the physics engine will selectively increase resistance (decrease user speed) when climbing hills etc.

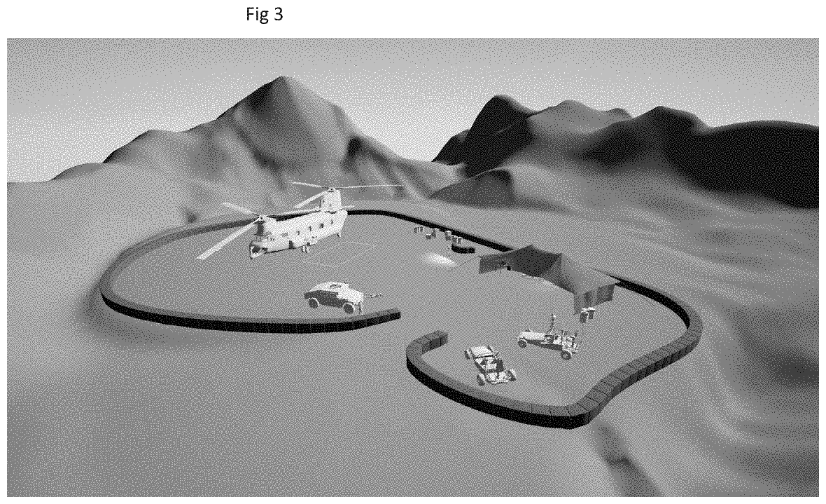

With a full understanding of the area of activity and environment variables, proper assessment can be made for the collection of assets or the “ingredients” to the recipe of successful batch of missions. The revision of these recipes will occur by way of intuition prompts that can occur by various features/actions/layers including: walkthrough; collaboration; visualization and preparation. Assets can be queued in the staging area See FIG. 3. Assets can include, but not limited to: Boats; Tanks; Aircraft; ATV; Buggies; Motorcycles; Beasts of Burden; and Wildlife, etc. After assets and method are decided, areas can be populated with expected good and bad actors and scenarios run. Actors can be artificial intelligence driven or networked participants who can be in overview or in immersed modes for a full-scale joint simulation.

For a training session in a mixed reality event, such as a shoot house, the AR goggles can have an input such as a QR code which will allow the change to the background of the walls from for example shipping containers or a mud hut, or a Williamston colonial with a picket fence. As is described, data is feed to the AR goggles using the visualization engine. Biometic and reaction data is captured during the event for analysis later.

Playback of the scenario is possible from a variety of camera angles where the operation can be assessed and streamlined to decrease cost from a variety of aspects: Human; Machine; Animal; Monetary. During a training phase in VR, or AR training, the virtual simulation is the ability to rewind and evaluate many scenarios, many times.

During the Execution of the Mission, the first user or commander can view the goings on of the mission in VR space. This VR space can be augmented using image data that augments the VR space in near real time. This data can come from satellite and drone imaging data. This data can be used to provide AR Prompts to the users during the mission. For example, data can be live streamed to the war fighter to allow them to avoid collisions on the road during driving, or provide better troop location formation with live enemy trackers in respect to live 3d mapping.

Importantly, intuition prompts in the form of information pushed into the AR goggles during a mission can visually alert a soldier to changes in the environment which they may not be aware of. This can be for example the movement of a vehicle into and area, the movement of soil which may indicate the placement of an IED, the visual acquisition of a potential sniper on a roof. Colored decals can be placed into the AR space and visually alert the soldier to the new information.

The AR headset, when used in the field can have a provision which will allow for solider to increase or decrease the amount of information within the goggles or AR screen. The sandbox and augmented reality displays can include goggles; include tablets or cell phones as well as mission planning of the battle space and military manuals. The system can utilize body part sensors in virtual reality and a tank turret. In the mixed reality situations, the system can utilize weapon-mounted sensor for weapon direction.

In the mixed reality situations, a trainee can be evaluated preconditioned conditioned and post conditioned using Virtual Reality, Augmented Reality and/or Mixed Reality so this could turn out to be a testing scenario to filter participants with respect to preferred traits for preferred objective goals/outcome. This can include the measuring biological inputs such as heart rate and reaction times when changes in muscle tension are compared to the timing of visual cues.

The system is backpackable at the scout level, and provide hardware connection to other users around the globe. Additionally, maps can be updated in the field by imputing optical and sensor data from hand thrown drones. Enterprise and heavy level hardware and software connection can be provided to allow for cloud based calculation of the graphics. Geo-referenced intelligence images and cross platform capabilities can be used to provide multiuser support.

With respect to the electromagnetic atmosphere, the VR and MR system can be used to display and show a scan cellular flow of cell phones for enhanced civil planning to track how many cars go which way, as well as the location of various towers.

Images of oil-ground scans provide locations of minerals/oil geo-referenced in the ground to augmented reality. Drilling for water reference local aquifer map while drilling for water wearing AR goggles you can see how close your pipe is in relation to aquifer. Differences in 3D landscape reality to provide prompts on areas of further inspection.

As described, intuition prompts identifying differences to users using intuition prompts in the form or VR, MR, and AR prompts to the user. The prompts can take the form of visual cues displayed, text, and haptic output. For example, the system can identify to a user; “I see footprints there” or “I see fresh car tracks” or the ground in that region appears to have been displaced, or there is a hole here that wasn't there but was filled in. Optionally, these areas can be highlighted visually with a color such as a warning red.

When there is incomplete or old data in high priority areas, the System AI can display prioritized drone flight patterns to Focus Surveillance Detection On differences based on 3d landscape and Indicators differences and anomalies human activity. When data is ole or incomplete, these areas can be highlighted as being suspect within the VR/AR environment. The System AI can use machine training, machine learning based on anomalies detected over time.

The prompting augmented reality goggle wearing individual which way to face his head to provide more information on newly found difference. During the mission in AR and MR, intuition prompts not limited to just humans. Intuition prompts can be provided for animals such as for dogs. These intuition prompts can be made via vibration, tones (audible and inaudible to humans), and radio communication. Optionally, sensor platforms can be integrated onto the animal using harnesses of for example dog helmet cameras.

Different type of Geo-referenced Data can be combined in a fashion that is best understandable to humans in AR VR. For example, it better to show white hot thermal people on top of colored visible camera textured 3d models or red outlined movements noticed by LIDAR. In another example, if there is a VR dataset that corresponds to a physical topography, each having a desk, and a first user places an object on the desk in the VR space, a second user, when viewing the desk through an AR display will see the object on the real desk. Similarly, the systems engines can provide data directly to the AR goggles in the real world to augment a soldier's situational awareness and provide intuition prompts.

The AR and VR screens can display where hits are made with weapons and can calculate probability of lethality and offer indication as to keep shooting or not. Facial and or voice recognition indicates whether bad actor is High Value Target or pawn. Optionally the intuition prompts shows target-to-target head or leg. Additionally, AR medics can be positioned with the AR goggles to interact with an injured soldier.

The display engine will track all users for easy teleportation within the VR space. The sandbox view represents a Minimap that shows user positions and includes a RangeFinder—Point to Point, User—Identification, a Compass that can be sky compass in VR and AR situations. The system contains a database of weather options that will affect for example travel speed, visibility.

Disclosed is a method of sharing a three-dimensional virtual reality space among a plurality of users. The method contains the steps of first, acquiring a plurality of images of a geographic region using a mobile platform. Second, photogrammetry is used to create a first set of three-dimensional graphics data associated with a geographic region to be used by the plurality of users in a shared manner. Next, the three-dimensional graphics data is functionally cooped to a physics engine configured to physical rules to objects within the virtual reality dataset. A display engine is coupled to the physics engine to convert the dataset into first and second content streams. Either one of the first content streams and second content streams from the three-dimensional graphics data is the presented to one of a table, a computer, or to a VR headset.

The first content stream can include streaming a rendered topographic landscape. Alternatively, streaming a second content stream can include streaming the second dataset has an augmented reality content that is less than the content of the first dataset.

As previously discussed, capturing a series of images for a terrain using a drone and converting into a captured set of images and into a wire frame of the topographic landscape. The topographic landscape can be synced to a real world located using a fixed coordinate system. A set of polygons are provided over a wire frame to form a virtual reality image dataset.

The first VR image dataset can include includes a selecting engage able virtual sand table which gives an overhead view of “gods view” of the entire topography, and in VR data space topography. The second data set can be engaged, by selectively pointing to a spot on the sand table with a VR pointer to “move” the user into the second VR space represented by the 3d area in the map. This allows the user to traverse inside the vr second space in room scale.

A system for training a person according to the present teaching includes a camera or cameras used to capture a series of images of a terrain. These cameras are mounted on a mobile platform which can be a drone or a terrestrial based vehicle. The images are transferred to a computer using a cable or a memory card. The computer preferably has a GPU to efficient handle the data. The images stored in a file structure are converted using photogrammetry into a 3d model of the terrain. This 3d model formed from the image data series of the terrain is converted into a wire frame of the topographic landscape. The wire frame is synced to the topographic landscape to a real world located using a fixed coordinate system within a VR system. A physics engine is used apply structure to objects and topography found within the VR image dataset.

As shown in FIG. 2, a first image dataset is streamed to a VR display which represents a tent or a hanger having a “table sized” map of the terrain disposed several feet off the floor of the virtual space. An overhead 2d map to the area is formed and positioned on the wall of the hanger or room. Additionally, streaming content from for example the internet or a software defined radio can also be placed in the first VR space.

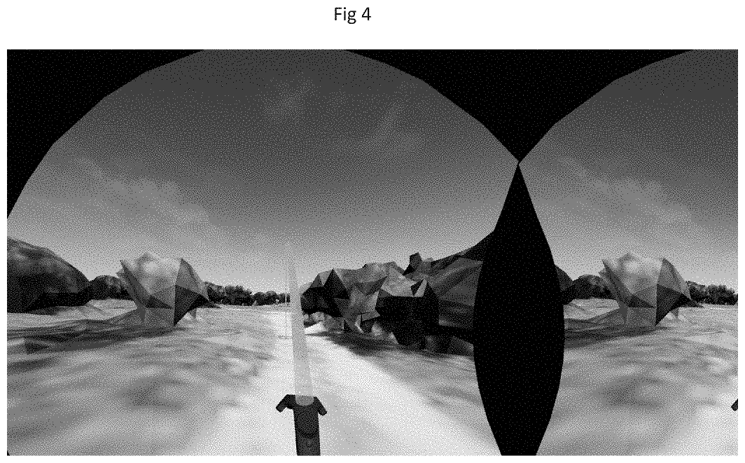

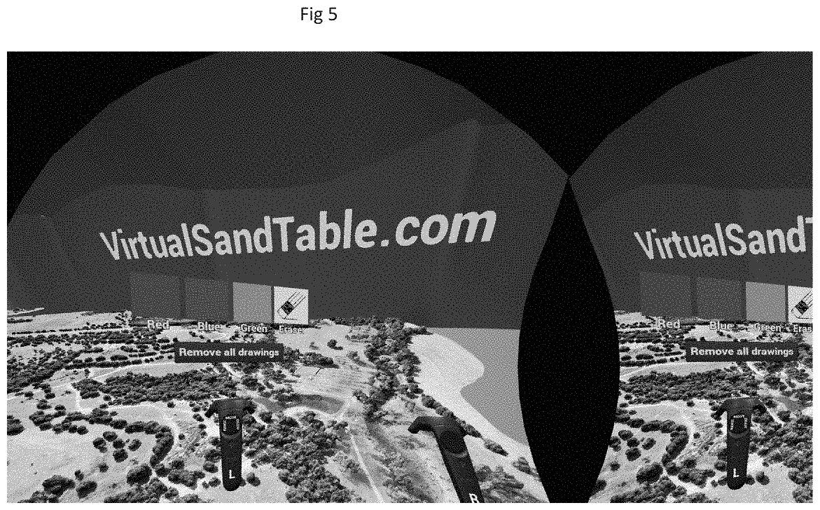

Additionally, as shown in FIG. 4, a pointer in VR can be used for instance to accurately determine things such as shot distance and angles between two points. These didcances can be correlated for image correction with know distances in the real world. As shown in FIG. 5, a user or users can surround the virtual sand table representation of the terrain and can use virtual tools such as paint brushes to paint infill and exfiltration routes, place vehicles such a helicopters, or Humvees, or rally points. Images from drones can be directly superimposed onto the mesh for “image” feeds. Which will give the VR either in the Room scale or in the “hanger” a view of what is happening “live.” This is of course subject to the normal latency in the system.

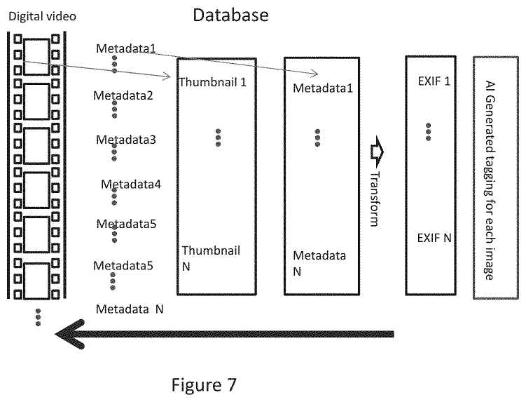

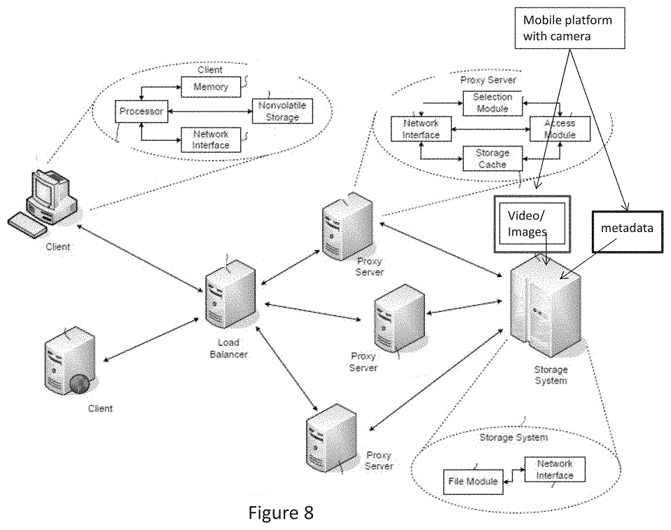

FIGS. 7 and 8 represent a system which is used to convert video streams from drones into a 3d or 2d output. The video streams are formed of a series of images which can be compressed and an associated set of meta data. The meta date can hold for example information regarding the mobile platform such as the drone type, the orientation, altitude and speed of the drone. Additionally, the meta data can contain information related to the camera type, focusing measurements, and angles and position of the camera with respect to the drone or ground. This meta data and thumbnail images for reach frame are copied into separate data tables which are relationally bound using a film frame reference number. It is often the case that the metadata does not include information needed to assist in photogrammetry.

Furthermore, the metadata may not be in a format (such as EXIF) which is used by the photogrammetry transforming software. This metadata for each frame can be transformed and saved into a second data table which is relationally bound using a film frame reference number. This transformed table can be filled with data which is calculated from data stored in the first data table. For example, the focal length can be transformed using the following formula:

Angular Field of View (degrees)=2×tan−1(h/2f); where h is the height of the imaging sensor.

Where f is the focal length which is usable by the photogrammetry processing. This data is used in the photogrammetry portion of the system to transform the images into a mesh as well as 2D and 3D images. Once the images are separated, the Meta data is used to segregate the data into separate sets. These discrete sets will be used separately to be run through the photogrammetry engine. In this regard, the images and metadata in the first and second data tables are separates into groups. The segregation occurs based on data stored in the Meta data. The system will incrementally through the metadata for changes in data such as a change in focus, a change of angle of the camera with respect to the drone, or earth. Once a “new set” have been started, the system will increment through the images until it comes across a new set of images based on the aforementioned changes in the camera's relation to the drone body or the ground.

Each of these segmented sets of images can be separately evaluated. If a single segment has too many files for effective transformation into a 3d and 2d map a subset for these images can be used to transform the data. In this regard, every 5th or 12th image can be used. Additionally, in situation where a pilot is changing the focus on an object or changing the field of view, the photogrammetry portion of the system can treat this as a separate and independent camera. Multiple subsets of photos can be used to form the mesh and the 3d image.

Also associated with each from can be additional metadata such as indicators of what might be found in a particular frame such as from AI. The AI can use machine vision techniques to label information of those things within a particular frame, such as a plane, tank, and rocket launcher.

To allow for the searching of images within the database, the system allows for the formation of a mathematical model which represents an image being investigated. The search image of interest is converted into a digital format for processing by a computer. This image is input into the computer as an image file or can be scanned using known techniques. Optionally, key words are associated with the image file. These key words can be associated with the goods or services related to a product.

The series of master transformation and analysis are conducted on the image file. In this regard, if necessary, the image is transformed into a grey scale or black and white image. As the master image file is expected to be of high quality, it is envisioned that needed image transformations will be at a minimum.

A series of analysis are run on the master or transformed image to characterize an object or objects depicted in the image. Properties such as centroid of the object, the object's aspect ratio, spline equations which describe parts or all of the object's edge, and character recognition can be run.

A correlation matrix is formed from the results of the analysis. The system evaluates the features or analysis, which best distinguishes the object being detected. This analysis can be for example a convolution solution such a convolution integral. In this regard, a convolution solution is a mathematical operation that combines the output response of a system to individual responses. In this regard, a solution or solutions is conceptually a fold, shift, multiple or summation of individual discrete, scaled, time-shifted impulse responses. Analogously, this maps to a multiplication of the functions in the frequency domain.

Efficiency and applicability of the methodology arises from the commutative property. Included (see end of document for the Pattern Classification Decision algorithm) is an adaptive learning algorithm that extends, in addition to the convolution solution, heuristic method that abstracts and generalizes to the degree to that it interprets the overall results. To reduce computational load in the future, those features having the highest likelihood of being able to distinguish the object are used to search for images as described below. These features represent a subset of the correlation matrix or a test function set.

Optionally, the system will ask whether the detection of rotated objects is required. In this case, the system will optionally rotate the master image about a predetermined axis, at a predetermined angle, a predetermined number of times. For example, the image can be rotated at plus or minus 5 degrees for 0 to 45 degrees. These rotations can occur about a centroid of the image to accommodate for scanning errors or can be located at a centroid away from the image to represent a 3d rotation in space. When the axis of rotation is located away from the image, it can be perpendicular to or within the surface of the image. All of these rotated images can then be run through the analysis system as described above.

It should be understood that the order of processes can be altered as desired. It is envisioned that those analysis techniques which have been deemed proper for one image may or not be deemed proper for its rotated analogues.

The system allows for searching images within a distributed network or database. The distributed network is run based on key words. This will significantly reduce the number of html pages to be evaluated. A determination is made if files on the target list have associated image files. Should there be associated image files, the images are downloaded for further analysis.

An initial evaluation of the images is conducted. In this regard, simple evaluations are conducted as to the determination if the image is larger than a predetermined size. By way of non-limiting examples, further preliminary analysis can be conducted to determine if images contain too many colors or if the color content is correct. For those images to be deemed worthy of analysis, the system can convert the images into grey scale.

A series of analysis are run on the images to determine how close the image is to the master image. In this regard, it is envisioned the image can be processed to segregate individual areas of a downloaded image for analysis. This segregation is performed using edge detection techniques. It is envisioned the system will conduct edge detection such as, but not limited to, convolution, converging square systems, or other edge detection techniques. To improve the success of the edge detection, the image can be preprocessed prior to analysis using edge enhancement and field flattening techniques.

Once portions of the images are segregated, each of the test functions can be run on the individual segregated image portions. Each image portion having its own correlation matrix can be then ranked for review after being compared to the correlation matrix of the master image.

The correlation matrix can be formed using the analysis. It should be noted that to improve computational efficiency, a subset of the analysis of those used can be used to analyze the image in the distributed network or database. This subset can be, for example, those analysis techniques determined to best correlate the master image. To increase the accuracy or robustness, the number of analysis techniques can be increased. The results of the correlation matrix the components of the image can then be compared to the master image correlation matrix. The correlation matrix for the varied components of the varied images can then be ranked for human evaluation. It should be noted that the images being evaluated can be compared with correlation matrices of the rotated images should this be desired.

Referring now to FIG. 8, a simplified block diagram of an example implementation of a system according to the present disclosure is depicted. Clients and send image file access requests to a load balancer. The load balancer assigns the image file requests to one of proxy servers. Although more or fewer proxy servers can be used, three are shown for purposes of illustration only.

The proxy servers retrieve and store large files from and to a storage system. The large files are aggregates of image files. In various implementations, proxy servers provide an interface between image file accesses and large file accesses. In other words, the proxy servers interact with the clients in terms of image files, and interact with the storage system in terms of large files video files.

The clients are graphically depicted as a personal computer and a server, respectively. However, in various implementations, clients can take many other forms, such as mobile devices which rung image presentation software such as ATAK. Further, although the term client is used, the client may not be the end consumer of information/data in the image files. For example only, the client may be a web server that retrieves small files and presents them as part of a web page or web application to end users. This can be run on for instance a Linux LAMP server.

A simplified block diagram of selected components of the client is illustrated for example only. Although depicted with respect to the client, similar or identical components can also be included in other clients, such as the client. The client, in this example, includes a processor that executes instructions stored in memory and/or nonvolatile storage. The processor communicates with a network interface. When the processor decides to access a small file, such as based on a user requested new content, the processor 402 transmits a small file access request to the load balancer 430 via the network interface 408.

In various implementations, the load balancer 430 may appear as a single server to the clients. Alternatively, the load balancer may be bypassed or omitted, and the clients may communicate with one or more of the proxy servers. For purposes of illustration only, selected components of the proxy server are depicted. In this example, an access module receives an image file access request via a network interface.

The access module determines large files corresponding to the specified small file according to a selection function from a selection module. The selection module may configure the selection function so that files expected to be accessed contemporaneously are grouped into a large file. For example only, files related to a web page may be grouped into a large file. Similarly, files that may often be accessed in succession as a user navigates a website may be grouped into a single large file. The access module 446 then accesses the corresponding large file from a storage cache 452. When the storage cache 452 does not include the large file, the large file is read from the storage system 460.

For purposes of illustration only, the storage system is shown as including a network interface and file module. The file module may implement a variety of file systems, such as FAT, NTFS and/or ext2. The file module may include a variety of nonvolatile storage media, such as tape optical disk and magnetic storage. The file module may implement a variety of storage techniques, such as RAID (redundant array of independent disks). The file module may be unaware of the content of any of the large files and simply treat them as standard files.

Image data processing generation, specially adapted particular applications. This can include indexing scheme image analysis image enhancement; special algorithmic details; image segmentation details; active shape model. The system can be specially adapted for particular applications and can include geometric image transformation plane image, bit-mapped bit-mapped creating different image.

Image data processing for the VR and AR goggles can include generation can include specially adapted particular applications including image analysis, bit-mapped non bit-mapped, depth shape recovery, multiple images, multiple light sources, and photometric stereo.

Real-time bi-directional transmission motion video data can be accomplished using network structure processes which are specifically adapted to use a video distribution server and client remote clients. Data switching networks and wireless communication networks can be used for control of signaling. Basic layer enhancement layers can be transmitted using different transmission paths, setting peer-to-peer communication internet remote stb's. Communication protocols including addressing, signaling, control architecture real-time multimedia are used to maximize throughput.

The system can use peer-to-peer communications with control signaling network components server clients, network processes video distribution server clients, controlling quality video stream, dropping packets, protecting content unauthorized alteration network, monitoring network load, bridging different networks, ip wireless. The control architecture allows for near real-time multimedia communications.

The system can use a broadcast conference packet-switching network including real-time bi-directional transmission motion video data. Servers are specifically adapted distribution content, vod servers; operations; management operations performed server facilitating content distribution administrating data related end-users client devices, end-user client device authentication, learning user preferences recommending movies. The system provides integrated maintenance administration data networks.

Broadcast communication is managed using circuit systems communication control processing protocol. The use of Broadcast conference packet-switching networks in real-time in bi-directional transmission motion video data specifically adapted video distribution server client remote clients. Data switching networks and wireless communication network including a video encoder decoder, transmission management data server client, sending server client commands recording incoming content stream. The Protocols client-server architecture is specially adapted downstream path transmission network.

As previously mentioned, the system provides selective content distribution arrangements, apparatus, circuits, and systems communication control processing protocol. Broadcast conference packet-switching networks are used for the real-time bi-directional transmission motion video data and generation processing content additional data content creator independently distribution process. Arrangements generating broadcast information, the assembly of content and the generation multimedia applications.

Electrical digital data processing using where computers computation affected self-contained input output peripheral equipment. Optionally, impedance networks using digital techniques, error detection, error correction, monitoring, and methods for verifying correctness marking record carrier can be used. Error detection and correction of data is included using redundancy hardware or using active fault-masking. The system will automatically switch off faulty elements and switch to spare elements. Interconnections communication control functionality redundant; flexible arrangements bus networks involving redundancy. Defective hardware can be detected and located by testing during standby operation idle time, start-up.

Database structures are provided containing file structures for data processing systems. Methods specially adapted administrative, commercial, financial managerial, supervisory forecasting purposes. The system uses data structured data stores including storage indexing structures; management. The engine uses computers computation effects the input output peripheral equipment using indexing scheme relating accessing, addressing allocation memory systems architectures; details cache specific multiprocessor cache arrangements.

The AR system allows for the management of power consumption, standby mode; power saving data processing device general and wake-up procedures. Recognition data and methods arrangements reading recognizing printed written characters recognizing patterns, fingerprints; processing analysis tracks nuclear particles and chemical constituents, molecular sequences; radio frequency.

The visualization engine allows for the system to utilize recognition field perception and scene-specific objects. Image and video retrieval and image analysis and image segmentation is included. Pixel labelling and alarm systems, traffic control, pictorial communication, recognizing scenes, perceived perspective of the user. The system allows for the recognizing of patterns in remote scenes, aerial images, vegetation versus urban areas; radar similar technologies; segmentation general image processing; using hyperspectral data, i.e. Wavelengths rgb.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

Addressing the ability to suggest or even force movement of the user. In some embodiments, the use of vibrational stimulators provides feedback to the user. This allows for force feedback, which in VR, could be implemented as directors nudges/encouragement to ensure that the participant is not missing key cinematic or other important events.

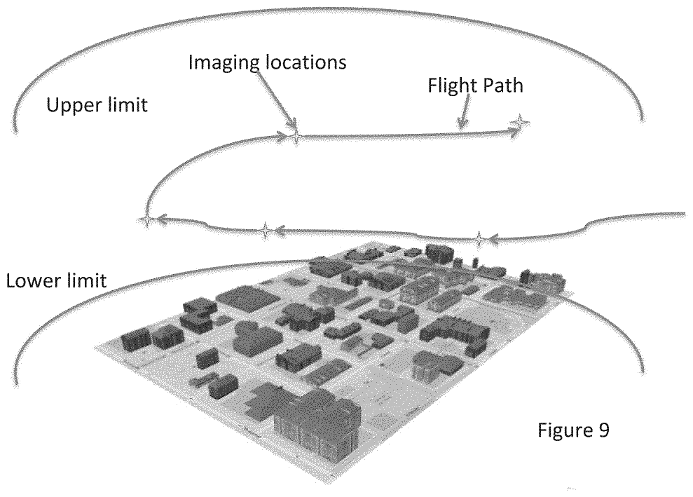

FIG. 9 represents a system for optimizing a flight plan for an aerial and or mobile observation platform. In this regard, the flight plan can be optimized to maximize one or more of several different results. The first can be, what is the shortest flight path above a specific topography which allows the minimum number of 2d or 3d (lidar) images which can be used to form a three dimensional dataset of a surface or topography at a desired image quality. The second can be, what is the flight path or paths which maximize the time a mobile platform can observe the most area or surfaces at any given time at a desired image quality. Another optimal path can be the avoidance of regions the platform or camera cannot operate optimally. For example acoustical requirement, or danger.

The system utilizes a low-resolution 3d wireframe or sparse map of a topography of interest, covered with faceted polygons to define surfaces. This resolution can be for example (1 pixel per meter). The low-resolution map is placed into a 3d physics engine such as, by way of non-limiting example, an Unreal Engine. An air space of 3d locations is defined above the map of the topography of interest. Included in this airspace is a floor limit, which can be set, based on safety or noise requirement of the mobile platform. Also included is an upper limit, which can be set, based on the camera requirements or operational parameters of the mobile platform to allow the desired image quality (for example less than 1 pixel per ground 2 cm and more particularly less than 1 pixel per ground 1 cm).

As described below, the system uses ray tracing to determine which locations in the space of 3d locations are optimum for capturing images of the terrain. Once the system determines which locations are optimum, a 3d traveling salesman solution is defined to determine which optimum (shortest) flight path is needed to capture the minimum number of 2d and 3d images needed to form the high resolution 3d image. Or if a optimum flight zone is determined, the central location of this zone can be used to reduce error. By way of non-limiting example, the system can have a computer which implements one of the following solutions to the traveling salesman problem. Various branch-and-bound algorithms, Progressive improvement algorithms, Implementations of branch-and-bound and problem-specific cut generation, this is the method of choice for solving large instances. A cutting-plane method based on linear programming, a Concorde TSP Solver.

For each location in the air space of 3d locations, a projection is recursively made onto the space low-resolution surface. The system determines which triangles are visible from each location in space. The each location in the space of 3d locations is then sorted to determine at which location the largest number or surface area of triangles is visible as well as the smallest number of triangles are not visible because of obscuration. A cluster of these locations is then stored in a separate memory location or tagged as primary imagining points. These observable n-gons will be labeled “unobscured.” The system will then determine which locations within the air space of 3d locations has an unobsucred path to the largest number of “obscured triangles.” A cluster of these locations is then stored in a separate memory location or tagged as secondary imagining points. These now observable triangles will be labeled “unobscured.” The system will continue to recursively evaluate locations in the air space of 3d locations until a point where the number of obscured triangles is below a predetermined threshold.

Optionally, the reverse process is possible, where observations are made “from the triangles” to determine which are the locations in the air space of 3d locations which are available. Once a series of locations the air space of 3d locations where the number of obscured triangles is below a threshold. The system uses a 3d traveling salesman solution to solve which is the shortest path in space of 3d locations.

It should be noted, that the solution is fairly straightforward when utilizing a rotator lift aircraft such as a quad copter. When using a fixed wing, the relative distance between points in airspace changes depending on the angle of attack of the location in space. For example the kinematics such as speed and inertial of an aircraft may limit the angle of the approach in a manner such that the aircraft will need to turn around and approach a near neighbor observation location.

Once optimum path is determined, the flight plan and imaging plan is loaded into the aircraft. A breadcrumb trail of images can be taken at a predetermine frequency to ensure proper image overlap to assist in stitching together the images, as can be done in photogrammetry and lidar map construction.

Additionally, it is envisioned that the above system can be used to determine the best locations from legacy video streams to construct 3d maps, such as the images discussed above with respect to FIGS. 7 and 8. In this situation, the 3d airspace locations will be limited to those locations where images have been taken from the legacy map. This reduced subset of locations will be used to determine the minimum number of locations, and thus images from the legacy data, which will be needed to transform the legacy data into 3d maps.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Various implementations of the systems and methods described here can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications, scripts, or program code) include machine instructions, for a programmable processor, and can be implemented in a high-level procedural and/or object-oriented programming language, and/or in assembly/machine language. The computer programs can be structured functionality in units. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more sets of computer program instructions encoded on a computer readable medium for execution by, or to control the operation of, data processing apparatus. The computer readable medium can be a machine-readable storage device, a machine-readable storage substrate, a memory device, a composition of matter affecting a machine-readable propagated signal, or a combination of one or more of them.

The terms “data processing apparatus”, “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more sets, sub programs, or portions of code). A computer program or engines can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio user, a Global Positioning System (GPS) receiver, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

One or more aspects of the disclosure can be implemented in a computing system that includes a backend component, e.g., as a data server, or that includes a middleware component, e.g., an application server, or that includes a frontend component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specifics, these should not be construed as limitations on the scope of the disclosure or of what may be claimed, but rather as descriptions of features specific to particular implementations of the disclosure. Certain features that are described in this specification in the context of separate implementations can also be implemented in combination in a single implementation. Conversely, various features that are described in the context of a single implementation can also be implemented in multiple implementations separately or in any suitable sub-combination.

Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Upon reading this disclosure, those of skill in the art will appreciate still additional alternative structural and functional designs for a system and a process for deep search in computing environments through the disclosed principles herein. Thus, while particular embodiments and applications have been illustrated and described, it is to be understood that the disclosed embodiments are not limited to the precise construction and components disclosed herein. Various modifications, changes and variations, which will be apparent to those, skilled in the art, may be made in the arrangement, operation and details of the method and apparatus disclosed herein without departing from the spirit and scope defined in the appended claims.

What is claimed is:

1. A method of sharing a three-dimensional virtual reality space among a plurality of users, the method comprising the steps of:
acquiring three-dimensional graphics data associated with a geographic region to be used by the plurality of users in a shared manner and an update object whose state is updated according to an operation performable by each of the plurality of users;
functionally coupling the three-dimensional graphics data to a physics engine configured to apply physical rules to objects within the virtual reality dataset, a display engine is coupled to the physics engine to convert the dataset into first and second content streams; and
streaming a first content set from the three-dimensional graphics data to a first VR headset and a second content set three-dimensional graphics data to second VR headset.

2. The method according to claim 1 wherein streaming a first content set includes streaming training scenarios and wherein the content set further comprises a rendered topographic landscape.

3. The method according to claim 1 further comprising a second content set that has an augmented reality content that is less than the content of the first content set.

4. The method according to claim 1 further including, capturing a series of 2d images for a topographic landscape using a camera mounted on an aircraft and converting the series of images for the topographic landscape into a captured set of images and onto a wire frame of the topographic landscape using photogrammetry.

5. The method according to claim 4, including syncing the topographic landscape to a real world located using a fixed coordinate system.

6. The method according to claim 4, including providing a set of polygons over the wire frame to form a virtual reality image dataset.

7. The method according to claim 1, including providing a second AR image dataset having less content than the first VR image dataset which is streamed to an AR display.

8. The method according to claim 1, wherein providing a first VR image dataset includes a selecting engageable virtual sandbox which gives an overhead view of the entire topographic landscape, and a VR data space topography.

9. A method of sharing a three-dimensional virtual reality space among a plurality of users, the method comprising the steps of:
acquiring a plurality of 2-D images of a geographic region using a mobile platform;
using photogrammetry to create a first set of three-dimensional graphics data associated with a geographic region to be used by the plurality of users in a shared manner;
functionally coupling the three-dimensional graphics data to a physics engine configured to apply physical rules to objects within a virtual reality dataset;
coupling a display engine to a physics engine to convert the dataset into first and second content streams; and
selectively streaming either one of the first content streams and second content streams from the three-dimensional graphics data to a VR headset.

10. The method according to claim 9 wherein streaming a first content stream includes streaming the first dataset which comprises a rendered topographic landscape.

11. The method according to claim 9 wherein streaming a second content stream includes streaming the second dataset having an augmented reality content that is less than the content of the first dataset.

12. The method according to claim 9 including capturing a series of images for a terrain using a camera mounted on a drone and converting the series of images for a terrain into a captured set of images and into a wire frame of the topographic landscape.

13. The method according to claim 12 including syncing the topographic landscape to a real world located using a fixed coordinate system.

14. The method according to claim 12 including providing a set of polygons over the wire frame to form a virtual reality image dataset.

15. The method according to claim 9 including converting the coupling the three-dimensional graphics data to a second AR image dataset having less content than the first VR image dataset which is streamed to an AR display.

16. The method according to claim 9 wherein providing a first VR image dataset includes a first engageable virtual sandbox visual content which gives an overhead view of the entire topography, and in VR data space topography visual content.

17. A method for training a user comprising the steps of:
capturing a series of images of a terrain using a ccd camera disposed on a mobile aircraft traveling over the terrain;
converting the series of images for the terrain into a captured subset of images and into a wire frame of the topographic landscape to form a VR image dataset;
syncing the wire frame of the topographic landscape to a real world location using a fixed coordinate system;
applying a physics engine to a object within the VR image dataset;
streaming a first image dataset stream from the VR image dataset to a VR display; and
streaming a second image dataset from the VR image dataset to the VR display.

18. The method according to claim 17 wherein capturing a series of images of a terrain using a ccd camera disposed on a mobile aircraft traveling over the terrain includes defining a flight path using CNC cutter-path system to define the path of a data collection drone to most efficiently calculate needed information for a variety of layers in a variety of spectrum.

19. The method according to claim 17 further includes providing a virtual tool that allows the placement of vehicles within the VR image dataset.

20. The method according to claim 17 further includes providing a virtual tool that allows visualization of the movement of people on the terrain and modifying the VR image set to include information related to the movement of people on the terrain.
